(19) United States
(12) Patent Application Publication
(10) Pub. No.: US 2003/0219602 A1
(43) Pub. Date: Nov. 27, 2003

(54) Ultrasonic joining of thermoplastic parts

(76) Inventor: Val A. Kagan, Morris Plains, NJ (US)

Correspondence Address: Honeywell International Inc., Roger H. Criss, 101 Columbia Road, P.O. Box 2245, Morristown, NJ, 07962, US

(21) Appl. No.: 10/109,197

(22) Filed: Mar. 28, 2002

(51) Int. Cl. B32B 9/04; B32B 31/16

(52) U.S. Cl. 428/411.1; 428/688

(57) ABSTRACT

A first workpiece having a first mating surface and a second workpiece having a second mating surface are joined by an ultrasonic welding method to form a joined article. Each of the workpieces is composed of a thermoplastic material. Joining is accomplished by a method comprising the steps of: (i) placing an auxiliary energy director in contact with the first mating surface; (ii) bringing the second mating surface into close proximity with the first mating surface and into contact with the auxiliary energy director; (iii) imposing a compressive force urging the first and second mating surfaces into contact; (iv) activating a source that applies ultrasonic vibration to one of the workpieces for a time sufficient to cause melting of at least a portion of each of the first and second workpieces; (v) discontinuing the application of ultrasonic vibration; and (vi) cooling the workpieces to allow the melted portions to solidify, thereby forming the joined article. The compressive force is maintained at least through the activating, discontinuing, and cooling steps. Articles of manufacture are economically and efficiently produced by the ultrasonic welding method without the presence of an energy director integrally formed in either of the workpieces. Molding of workpieces and final assembly operations are simplified. The welds have high uniformity and strength.

### BACKGROUND OF THE INVENTION

1. Field of the Invention

This invention relates to the joining of thermoplastic workpieces, and more particularly, to ultrasonic joining of thermoplastic workpieces initially having a planar abutment.

2. Description of the Prior Art

Modern thermoplastic, polymeric materials have found widespread and varied manufacturing applications. In many cases, articles composed of suitable thermoplastic materials have been found to be advantageous replacements for metal or thermoset articles previously required. In a given application, mechanical requirements can often be met with a thermoplastic article that is cheaper, lighter, and more robust than a comparable metallic or thermoset article. Thermoplastic items are now widely used in a diversity of applications available in the marketplace, including automotive and truck components, housings for household and light industrial appliances and electronic devices, and toys. Compared to metal or thermoset articles, thermoplastic articles are generally easier to form initially by molding, since their melting points are much lower, and they are easier to machine and handle in the course of manufacture.

Moreover, thermoplastic materials are electrically insulative, making them highly advantageous for use in small electrical appliances and tools, such as electric drills, hedge trimmers, kitchen implements and the like. Grounding and similar electrical precautions that would be required in an implement constructed with a metal case are eliminated by use of a thermoplastic case, reducing the manufacturing cost of the item and greatly improving user safety. The insulative properties also make thermoplastic materials desirable for constructing components of electrical switches, receptacles, plugs, thermostats, relays, circuit breakers, and similar devices. Frequently, thermoplastics are used for cases and internal components that are cooperatively joined with metallic conductors, contacts, and the like.

Being relatively chemically inert, many thermoplastics are widely used in making medical and surgical devices, many of which are intricate in design and complex to manufacture. The ability to form a joint between workpieces that is hermetically tight is frequently essential for these applications, as well as for ducts and pipes.

However, many of the shapes needed for articles in the aforementioned diverse applications cannot be formed conveniently and economically in a single operation. In other instances thermoplastic workpieces must be assembled to enclose other components. In either situation the only feasible manufacturing approach is to employ two or more workpieces that are subsequently joined to form the finished article. Together these requirements have imposed a persistent need for satisfactory joining methods appropriate for thermoplastic materials. Traditional methods entailing welding, brazing, soldering, and the use of known mechanical fasteners, that are widely practiced for joining metallic workpieces, are generally inapplicable for thermoplastics, which have markedly different thermal and mechanical characteristics.

Hot-plate welding methods are sometimes adequate for making geometrically simple systems. One or both of the workpieces are heated to melt the mating surface. The workpieces are then quickly brought into abutment and joined. However, reliable welding by this method necessitates tight process control and very careful mechanical handling to assure proper mating.

In other cases, solvent welding is used. In this technique, a solvent for the thermoplastic is first applied to one or both of the mating joint surfaces to soften them. The workpieces are then brought into contact, and the joint is allowed to harden. Significant environmental concerns attend many of the commonly used solvents. In addition, it is difficult [symbol] nate all of the residual solvent, so the technique is generally considered unsuitable for manufacture of parts intended for use in medical applications.

Frictional welding methods used with thermoplastic parts may broadly be classified as vibrational (linear and orbital), rotational/spin, and ultrasonic. In both vibrational and rotational methods the workpieces are brought into mating contact and moved relative to each other in a direction substantially in the plane of the joint surface while being urged together under compressive force. The resulting friction rapidly heats the joint area to cause melting and welding. With vibrational methods the workpieces are moved relative to each other in an oscillatory linear or orbital pattern. The rotational method (spin welding) entails rapidly spinning one of the workpieces and bringing it into contact with its mate. However, spin welding is suitable only for parts having joint surfaces that are cylindrically symmetrical. In addition, spin welding requires very precise alignment of the parts to get a uniform weld fully encircling the final article, which is essential if high strength or hermetic sealing is required.

Ultrasonic welding is widely applied for joining thermoplastics, especially for mass production in which high throughput and speed of welding are advantageous. Amorphous thermoplastics are regarded as most amenable to ultrasonic welding, especially if a hermetic joint is needed. However, the process is also widely used for semicrystalline, filled, and fiber-reinforced thermoplastics.

Similar ultrasonic processes are also used for joining thermoplastics to metals. Often the parts to be joined include stakes, rivets, inserts and the like. However, the joining is not welding in the usual sense that entails at least some melting of both the workpieces. Rather, application of ultrasonic energy causes part of the thermoplastic workpiece to melt and flow around the metal workpiece. Upon solidification a bond is achieved by mechanical interlocking of the respective parts. However, the absence of interdiffusion makes the joint strength critically dependent on obtaining a uniform and sufficient degree of melting and flow Joining methods involving an integral energy director frequently lack consistency. The resulting joints are often weak, with the result that reliable and improved techniques are needed.

Energy directors are necessary prerequisites for reliable formation of workpieces by ultrasonic welding and joining techniques. An energy director is a structure integrally molded into the mating surface of at least one of the workpieces to be joined. It often takes the form of a triangular or similar protrusion. The workpieces are positioned for welding with the apex of the protrusion contacting the opposite mating surface. The integral energy director is regarded as being essential to obtaining a joint with uniform strength and attachment.

However, provision of an energy director complicates the preparation of workpieces. The complexity and expense of molds required to produce workpieces with one or more energy directors is increased, since additional features need to be incorporated. The problem is particularly acute with small production runs and especially, for experimentation and prototyping. Each new design entails the time and expense of modifying a mold to produce the desired energy director structure.

U.S. Pat. No. 4,326,902 discloses a method for ultrasonic welding of composites to form a sandwich structure. The method is said to be particularly applicable to the joining of thin graphite-based thermoplastic composite sheets in space. The thin sheet material may be prepared and stored in rolled-up form prior to being joined. An ultrasonic welding process is accomplished using an energy concentrating member taken from a chain comprising a plurality of relatively flat members integrally formed from a flat stock of material having a predetermined thickness and shape and jointed together adjacent their peripheries by integral portions to interconnect adjacent members into a longitudinally extending chain. The chain-like structure of the energy concentrating member results in the formation of localized weld nuggets or nodes by which the bonding is attained.

Notwithstanding numerous advances in the field of ultrasonic welding, there remains a need in the art for an economical, efficient ultrasonic welding process for joining thermoplastic parts. The process needs to be capable of joining parts that vary widely in thickness, strength, and rigidity. Also needed is an ultrasonic welding process wherein the welds have high uniformity and strength. Further needed is an ultrasonic welding process causing minimal or no deformation of the external surface of the joined workpieces. Still further there is needed an ultrasonic welding process having the ability to bond welded joints over an extended, continuous area and to achieve hermetic sealing. These long awaited process improvements would be especially advantageous for purposes of prototyping and experimentation, without the necessity of integral energy directors.

### SUMMARY OF THE INVENTION

The present invention provides an economical, efficient method for joining thermoplastic workpieces using ultrasonic welding. Also provided is an article of manufacture produced by the ultrasonic welding process, wherein the welds have high uniformity and strength. The ultrasonic welding process causes minimal or no deformation of the external surface of the joined workpieces. Welded joints are bonded over an extended, continuous area, and hermetic sealing is achieved. The need for integral energy directors is virtually eliminated, causing the process to be especially well suited for purposes of prototyping, small production and experimentation.

In one aspect, there is provided a method for joining a first workpiece having a first mating surface and a second workpiece having a second mating surface to form an article joined at a joint, each of the workpieces being composed of a thermoplastic material. The method comprises the steps of: (i) placing at least one auxiliary energy director in contact with the first mating surface, each of the auxiliary energy directors being substantially continuous and elongated; (ii) bringing the second mating surface into close proximity with the first mating surface and into contact with the auxiliary energy director; (iii) imposing a compressive force urging the first and second mating surfaces into contact; (iv) activating a source that applies ultrasonic vibration to one of the workpieces for a time sufficient to cause melting of at least a portion of each of the first and second workpieces; (v) discontinuing the application of ultrasonic vibration; and (vi) cooling the workpieces to allow the melted portions to solidify, thereby forming the joined article. The compressive force is maintained at least through the activating, discontinuing, and cooling steps.

In another aspect, there is provided an article of manufacture comprising a first workpiece having a first mating surface, a second workpiece having a second mating surface, and an auxiliary energy director, the auxiliary energy director being elongated and substantially continuous. At least one of the workpieces is composed of thermoplastic material. The workpieces are joined by ultrasonic welding of the first mating surface to the second mating surface with the auxiliary energy director interposed therebetween.

Further, there is provided an article of manufacture comprising a first workpiece having a first mating surface and a second workpiece having a second mating surface, the article having been produced by a process comprising the steps of: (i) placing at least one auxiliary energy director in contact with the first mating surface, each of the auxiliary energy directors being substantially continuous and elongated; (ii) bringing the second mating surface into close proximity with the first mating surface and into contact with the auxiliary energy director; (iii) imposing a compressive force urging the first and second mating surfaces into contact; (iv) activating a source that applies ultrasonic vibration to one of the workpieces for a time sufficient to cause melting of at least a portion of at least one of the first and second workpieces; (v) discontinuing the application of ultrasonic vibration; and (vi) cooling the workpieces to allow the melted portions to solidify, thereby forming the joined article, the compressive force being maintained at least through the activating, discontinuing, and cooling steps.

Advantageously, the method of the invention allows thermoplastic workpieces to be joined by ultrasonic welding to form a welded article without the need for providing an integral energy director structure in the mating surface of one of the joints. Each of the mating surfaces can comprise a large, substantially planar area heretofore considered unjoinable by conventional ultrasonic techniques.

The provision of an auxiliary energy director apart from the workpieces affords significant advantages. The cost and complexity of the molding of the workpieces is reduced, since no energy director need be integrally formed. The resulting flexibility is especially useful in experimentation, limited volume production, and prototyping, since a range of experiments can be carried out to assess the effects of the number, form, and placement of energy directing structures without costly modifications of the molds or dies used to produce the workpieces. In addition, auxiliary energy directors can be provided with shapes incorporating transverse concavity, which heretofore could not be integrally formed using energy directors made by conventional molding processes.

The method of the invention is suited for the joining of workpieces composed of a wide variety of polymeric materials, including thermoplastics, filled materials, and fiber-reinforced materials. The energy director is typically composed of thermoplastics, thermosets, or metals, which need not be the same as the materials of the workpieces. Use of an auxiliary energy director having a slightly higher melting point than either of the workpieces is advantageous in some cases, in which the welding conditions are chosen to allow the energy director to maintain its identity and structural integrity during at least part of the welding operation and, in some instances, after welding has been accomplished.

In yet another aspect of the invention, a conductive energy director such as a metal wire is used to conduct an electrical current, thereby generating ohmic heat. This heating may be used to controllably supplement the heat produced by ultrasonic vibration. The ohmic heat may be used, for example, to pre-heat the workpieces or to induce local melting in the vicinity of the heated energy director. The use of a metal wire, with or without supplemental ohmic heating, also adds strength and stiffness to the joined parts in some cases.

With still another aspect of the invention there is provided a method of ultrasonically joining a thermoplastic workpiece and a metallic workpiece using a metallic auxiliary energy director. This method advantageously allows joining needed for the fabrication of various implements, notably including electrical devices.

### BRIEF DESCRIPTION OF THE DRAWINGS

The invention will be more fully understood and further advantages will become apparent when reference is had to the following detailed description of the various embodiments of the invention and the accompanying drawings, wherein like reference numerals denote similar elements throughout the several views, and in which:

FIG. 1 is a transverse cross-section view depicting the arrangement of workpieces and auxiliary directors in an ultrasonic welding system;

FIG. 2 is a plan view showing a plurality showing longitudinal, elongated, substantially continuous auxiliary energy directors placed atop a first workpiece for carrying out one aspect of the method of the invention;

FIG. 3 is a plan view showing a plurality of curvilinear, elongated, substantially continuous auxiliary energy directors placed atop a first workpiece for carrying out one aspect of the method of the invention;

FIG. 4 is a plan view showing a substantially continuous, elongated energy director atop a first workpiece having an annular mating surface for carrying out one aspect of the method of the invention;

FIGS. 5a to 5h are cross-sectional views depicting certain auxiliary energy directors suitable for use in the practice of the invention; and

FIGS. 6a to 6d are cross-sectional views depicting certain auxiliary energy directors suitable for use in the practice of the invention, and which exhibit transverse concavity;

FIG. 7 is a cross-sectional view depicting two workpieces and an auxiliary energy director exhibiting transverse concavity, the workpieces and auxiliary energy director being positioned for carrying out the method of ultrasonic joining of the invention; and

FIG. 8 is a cross-sectional view showing an arrangement for characterizing the strength of a joint between workpieces.

### DETAILED DESCRIPTION OF THE PREFERRED EMBODIMENTS

The present invention is directed to the ultrasonic welding or joining of thermoplastic workpieces using an auxiliary energy director separate from the workpieces. At least one of the workpieces is composed of a thermoplastic.

Generally stated, ultrasonic welding is accomplished by bringing two workpieces into mating contact at a joint surface. The workpieces are secured in contact and a compressive force is imposed to urge the mating surfaces into intimate abutment. Vibratory pressure is applied to one of the workpieces in a direction generally perpendicular to the plane of the joint surface. The vibratory pressure is generated by an ultrasonic driver comprising a source of AC electrical current that excites a driving transducer. Most commonly the driving transducer employs a piezoelectric ceramic, but other forms may be used including magnetostrictive transducers. The driving transducer produces mechanical vibration at a vibrational excitation frequency of about 10 to 60 kHz, with about 15 to 40 kHz being most common. The ultrasonic mechanical vibration is then conducted into the workpiece through a structure often termed a horn. The horn is generally composed of metal, preferably a hard metal, such as hard-faced titanium or hardened steel. The vibrational pressure is sustained for a time sufficient to cause interfacial melting and bonding of the mating surfaces. After sufficient vibration has been applied, the ultrasonic excitation is halted and the weld is allowed to cool. It is generally believed that the viscoelasticity of thermoplastic materials causes the ultrasonic vibration to generate substantial intermolecular friction, leading to a buildup of heat sufficient to cause local melting. Diffusion then causes sufficient entanglement between the polymer chains in the respective workpieces to produce a high strength weld. The compressive force is maintained at least through the duration of the vibration and cooling stages.

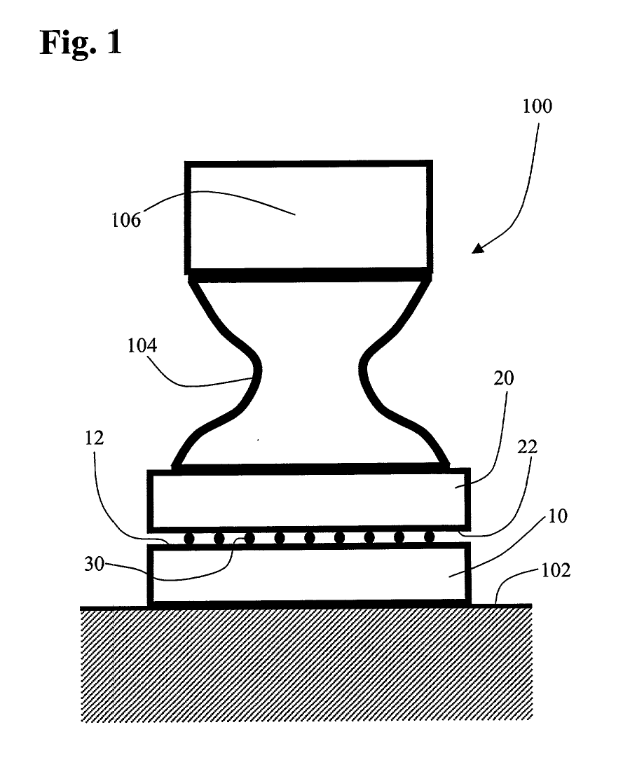

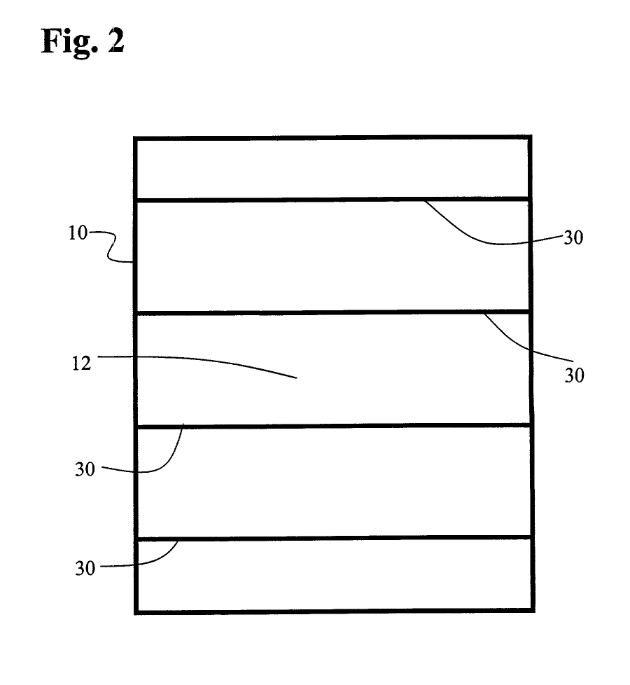

Referring to FIG. 1 there is depicted in accordance with the invention an arrangement for ultrasonic welding of a first thermoplastic workpiece 10 having a first, substantially planar mating surface 12 and a second thermoplastic workpiece 20 having a second, substantially planar mating surface 22. A plurality of round, wire-form auxiliary energy directors 30 are interposed between first and second mating surfaces 12, 22. The auxiliary energy directors 30 are substantially continuous and elongated. The placement of auxiliary energy directors 30 on mating surface 12 of first workpiece 10 is best seen in the depiction of FIG. 2. Ultrasonic welding apparatus 100 comprises substrate 102 on which first workpiece 10 is situated, ultrasonic horn 104, ultrasonic driver 106, and means for securely holding the workpieces 10, 20 to be joined. Ultrasonic horn 104 is in contact with second workpiece 20 and with ultrasonic driver 106. Ultrasonic welding apparatus 100 further comprises pneumatic or other means (not shown) for transmitting a static compressive force through horn 104 to urge first and second workpieces 10, 20 into intimate, abutting contact at their respective mating surfaces 12, 22, and with auxiliary energy directors 30. Ultrasonic welding apparatus 100 preferably comprises an active force control system based on sensing force and/or displacement as the joining is carried out.

The ultrasonic welding of first workpiece 10 to second workpiece 20 is accomplished by disposing the workpieces in the apparatus as depicted in FIG. 1 and activating ultrasonic driver 106 to produce ultrasonic vibration that is communicated through ultrasonic horn 104 to the workpieces 10, 20. The ultrasonic vibration is sustained for a time sufficient to cause softening or melting of a part of the workpieces 10, 20 at their respective mating surfaces 12, 22. The vibration is then stopped and the workpieces allowed to cool, and the joint solidified and hardened to effect the welding. The compressive force is maintained at least for the duration of the vibration and cooling steps.

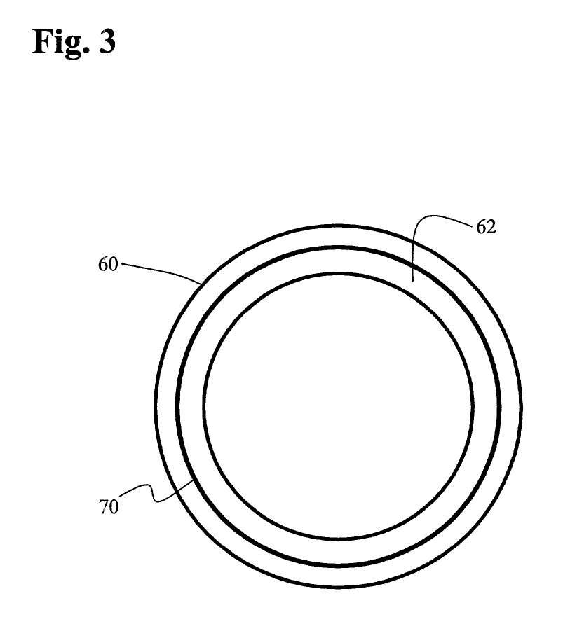

The present method may also be used to join workpieces having geometrical shapes other than the generally rectangular forms depicted by FIGS. 1 and 2. In another aspect of the invention, there is depicted in FIG. 3 a generally round workpiece 60 having an annular mating surface 62 appointed to be joined to an annular mating surface on a second workpiece (not shown). In this aspect, an elongated, generally continuous annular auxiliary energy director 70 is used. Round workpiece 60 and its mating workpiece are appointed to be joined using apparatus like that depicted in FIG. 1. This aspect of the invention is especially useful in forming flanged joints, such as are frequently required for joining the flanges of pipes, cups and the like.

Although the process of ultrasonic welding is widely used in industry, it has been regarded as being unsuitable for reliably joining two workpieces at a planar abutting joint surface without use of an integral energy director. It is generally found that attempting to ultrasonically weld parts with substantially flat mating surfaces lacking an energy director results in a weak, irregular joint, with bonding occurring erratically and only at randomly located areas within the weldment. It is believed that bonding occurs only in the vicinity of regions of the mating surfaces in which pre-existing asperities gave rise to limited intimate contact when the workpieces were brought into proximity before the welding operation was carried out. A substantial area of the mating surface is thus left unbonded, so the weld strength is unpredictable and generally low. Often the joint is not hermetic.

To overcome these difficulties and to attain a strong, uniform joint, the prior art has taught the requirement that at least one of the workpieces have an integral energy director, a structure molded into the mating surface of that workpiece and integral therewith. The energy director is thought to act as a stress riser, so that ultrasonic vibration imparted to the workpieces during the welding is concentrated in the region adjacent the energy director. As a result, melting is reliably and uniformly initiated in this region, wherein the buildup of heat is concentrated. Most commonly the energy director is in the form of a triangular-shaped protrusion or surface asperity or faceting used to concentrate and localize the ultrasonic energy. The energy director generally forms a ridge extending along the joint surface. Other geometrical forms of energy director are also known. All are formed integrally on the surface of the workpiece. Depending on the area and geometry of the joint either a single energy director or a plurality of structures may be used. Use of such an energy director is also generally found to yield good strength and uniformity without excess flash.

However, there are many instances in which the use of an integral energy director is expensive and inconvenient. The present method allows thermoplastic workpieces to be joined in a flat butt joint without the provision of an integral energy director. Advantageously, the molds for producing the workpieces need not incorporate structure for producing the energy director, thereby reducing their complexity and cost. The present method is especially useful in the experimentation, limited volume production and prototyping needed for developing new articles and joining conditions. A range of experiments is often feasible using the present method, which would otherwise be impractical and highly expensive if a separate mold were required for each variation. The method of this invention affords wide flexibility in the number, form, and placement of surface structures that act as auxiliary energy directors. Moreover, auxiliary energy directors can be made with complex cross-sections and concavities that cannot be readily obtained with conventional energy directors integrally molded in a workpiece. The use of an auxiliary energy director is also beneficial for small production runs, for which the amortization of mold costs is a significant cost driver for the final article.

In some cases an auxiliary energy director is advantageously made of a material different from that of either of the workpieces being joined. For example, an auxiliary energy director composed of a polymer compatible with the workpieces and having a melting point slightly higher than that of the workpieces, e.g., a melting point of up to about 60° C. higher may be selected. Upon application of ultrasonic energy, melting begins first in the vicinity of the auxiliary energy director. The auxiliary energy director beneficially retains its integrity, thus functioning to insure that a suitable melt pool is established, thereby promoting a high quality bond.

In another aspect of the invention, the auxiliary energy director is composed of metallic wire, and an electrical current is passed through the wire as a means of supplying heat to the weld region that supplements the ultrasonically generated heat. The ohmic heating of the wire can be controlled by regulating the flow of current. Such heat is used to pre-heat the weld region. Alternatively, a brief but intense flow of current provides local heating to initiate the melting needed to effect plastic welding. Although any metallic wire can be used, aluminum, copper, stainless steel, or nichrome are preferred. Copper and aluminum are especially useful, being easy to form and highly conductive. High resistance wire such as nichrome may be preferable for applications in which substantial ohmic heat is desired.

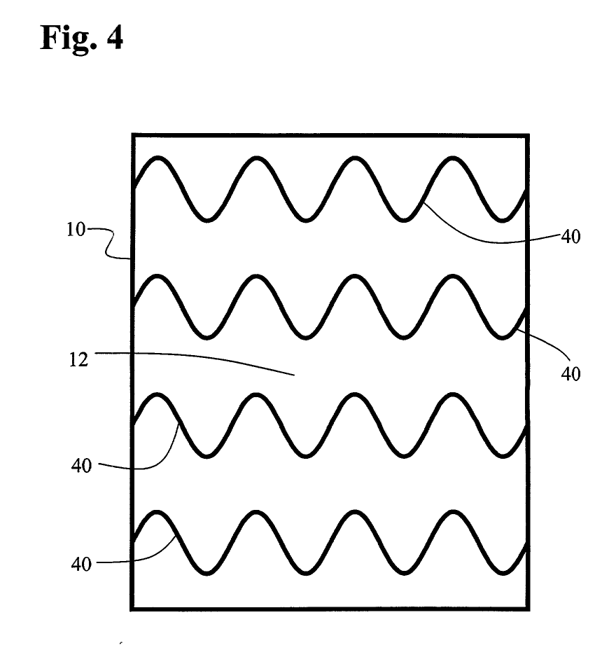

The use of metallic wire as an energy director also affords the further benefit of imparting added stiffness and shear strength to the joint. A curvilinear auxiliary energy director is preferred in this instance, as it strengthens the joint in shear two dimensionally. FIG. 4 depicts a generally rectangular first workpiece 10 having a substantially planar mating surface 12 on which are placed a plurality of elongated, substantially continuous, curvilinear auxiliary energy directors 40. Workpiece 10 is appointed to be joined to a second workpiece (not shown) using apparatus like that depicted by FIG. 1.

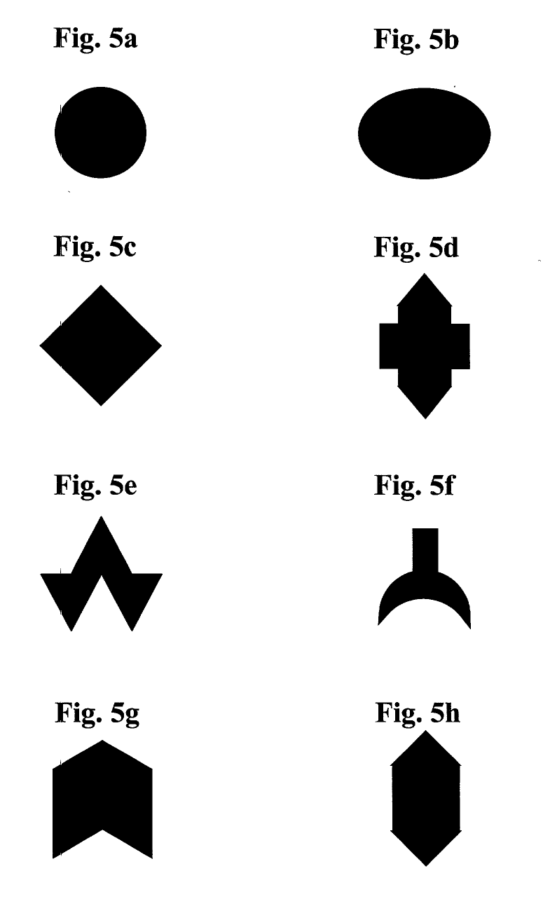

A number of geometrical forms for the cross-section of the auxiliary energy director are useful when practicing this invention. Generally it is preferred that contact of the auxiliary energy director with each of the workpieces occur over a limited area. Accordingly, wire with a circular or oval cross section represents a preferred form, since the contact with each of the workpieces is then at a point of tangency of the wire. Other preferred cross-sections are generally polygonal, so that contact with at least one of the workpieces occurs along a line, not over an extended two-dimensional, flat area of the auxiliary energy director. FIGS. 5a to 5h depict cross-sections of exemplary auxiliary energy directors useful in the practice of the invention. However, other structures are also useful, and will suggest themselves to one skilled in the art.

In some situations it is preferred that an auxiliary energy director be used that has a melting point substantially above the melting point of either of the workpieces to be joined in accordance with the invention. Such auxiliary energy directors may be made of metal, metal alloys, oxide glasses, or high melting-point polymeric materials, and so substantially retain their structural identity during and after the joining process is accomplished. When such energy directors are used, the joint strength may further be enhanced by virtue of the mechanical interlocking effected by flow and solidification of the workpiece around the energy director. Energy directors such as those depicted in FIGS. 5a to 5h will enhance primarily the shear strength of the joint.

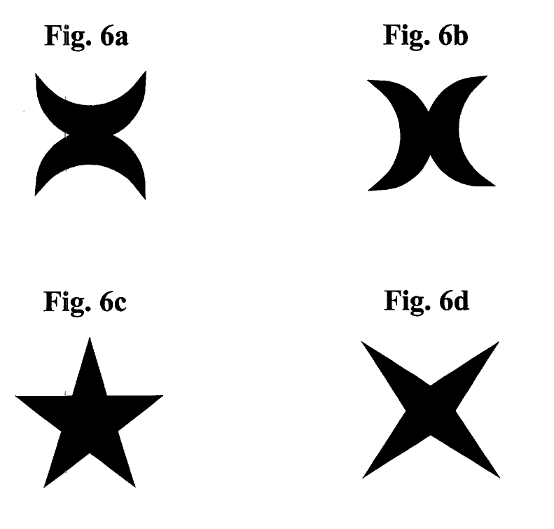

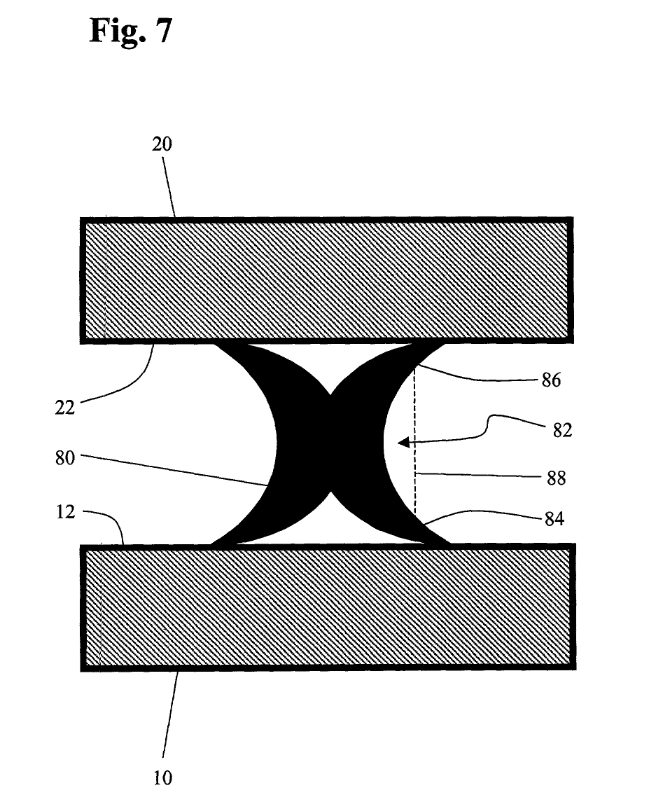

Other forms of energy director such as those depicted in FIGS. 6a to 6d will enhance the tensile strength of the joint by virtue of the preferable form of interlocking that results from their use. Each of the energy directors depicted in FIGS. 6a to 6d has at least one region of transverse concavity. By transverse concavity is meant a concavity that opens in a direction generally parallel to the mating surfaces of the workpieces to be joined. FIG. 7 depicts in schematic cross-section an auxiliary energy director 80 and first and second workpieces 10, 20 positioned to be joined by ultrasonic welding in accordance with an aspect of the invention. Auxiliary energy director 80 has a region 82 of transverse concavity on its right side and a similar region on its left side. Generally stated, a line drawn perpendicular to the mating surfaces crossing an energy director in a region wherein the director has a transverse concavity intersects at least two branches of the director with an open region between the branches. In the aspect depicted by FIG. 7, line 88 drawn generally perpendicular to each of first and second mating surfaces 12, 22 crosses branches 84, 86 of auxiliary energy director 80 in region 82 of transverse concavity. Region 82 is depicted on the right side of energy director 80, but it will be understood that a similar region exists on the left side of director 80.

The use of an energy director having transverse concavity advantageously enhances the tensile strength of the joint between two workpieces, since the flow of molten plastic from the workpieces flows around the director and into the transversely concave region. Upon solidification of the melt pool a mechanical interlocking results in enhancement of the joint strength in tension as well as in shear. Auxiliary energy directors having a region of transverse concavity may be made by a number of known techniques including casting, extrusion, rolling, die drawing, and the like.

The present process may be used to join a wide variety of thermoplastics including both amorphous and semicrystalline materials. In general the process may be used for joining workpieces either of the same material or materials known in the art to be chemically compatible. Representative lists of materials and their relative chemical compatibilities are found at pages 462 and 464 of Joining of Plastics: Handbook for Designers and Engineers, edited by Jordan Rotheiser (Cincinnati: Hanser Publishers), which pages are incorporated herein by reference thereto. In addition, filled or fiber reinforced materials can be joined.

In still another aspect of the invention, the present techniques may also be used to join thermoplastics to metals. Very commonly, electrical devices such as electrical switches, receptacles, plugs, thermostats, relays, circuit breakers, and similar devices employ thermoplastic cases or internal components that are cooperatively joined with metallic elements that serve as conductors, contacts, fasteners, or mounting hardware. In many cases the fabrication of these articles would be simplified and expedited if the thermoplastics could readily be joined to metal parts by ultrasonic joining processes that obviate the need for other fasteners.

The use of an auxiliary energy director in accordance with the present invention allows this joining to be accomplished simply and reliably. Application of ultrasonic energy causes part of the thermoplastic workpiece to melt and flow around the metal workpiece. Upon solidification a bond is achieved by mechanical interlocking of the respective parts. A metallic energy director is especially preferred for joining a thermoplastic workpiece to a metallic workpiece.

The following example is presented to provide a more complete understanding of the invention. The specific techniques, conditions, materials, proportions and reported data set forth to illustrate the principles and practice of the invention are exemplary and should not be construed as limiting the scope of the invention.

### EXAMPLE 1

### Preparation and Testing of a Joined Structure

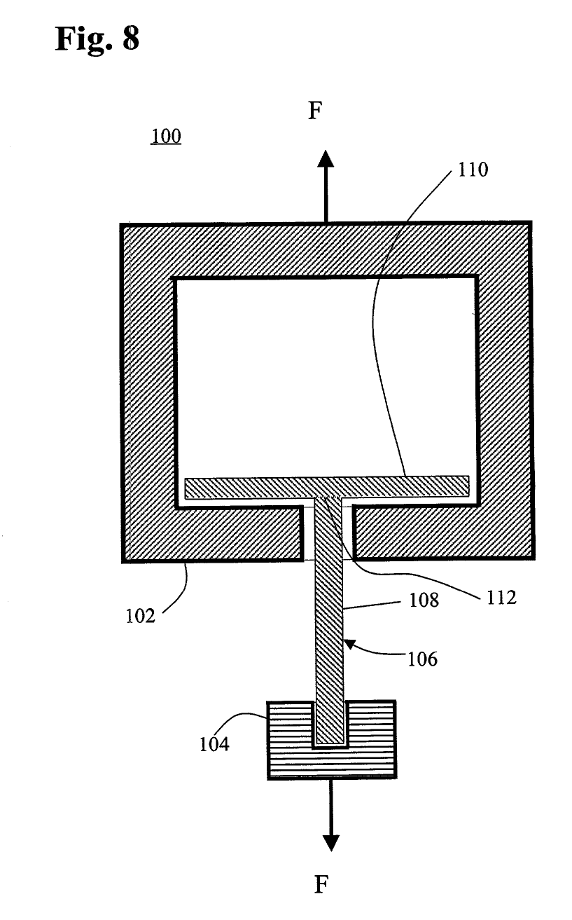

Several generally T-shaped test specimens were prepared from by sheet-form, 4-mm thick samples of nylon 6. In accordance with the sample protocol established in standard ISO procedure 527, a conventional ultrasonically welding method was used to form a joint between the cross-bar member atop the T-shaped specimen and a vertical member. The sample geometry is depicted in cross section by FIG. 8, showing sample 106 comprising cross-bar member 110 and vertical member 108 joined at joint 112. Test setup 100 comprises upper yoke grip 102, lower grip 104, and sample 106. The grips are positioned in a standard mechanical testing machine (not shown) appointed to apply a force F to the top and bottom grips 102, 104 affixed to the sample by known means. The strength of joint 112 is characterized by the force required to cause failure thereof.

Each of the samples tested had a cross-bar member 40 mm wide and 150 mm long and a vertical member 50 mm high and 150 mm long. Three specimens were prepared using nylon 6-based materials available commercially from Honeywell International Inc. The first sample was composed of members of CAPRON® 8202 HS, a material with no glass fiber reinforcement. The other two samples were made with members of CAPRON® 8231G HS and CAPRON® 8233G HS materials, which have fiberglass reinforcing fiber loadings of 14 and 33 wt. %, respectively. It was found that despite the support of cross-bar member 110 by yoke grip 102, member 110 exhibited considerable downward flexure during testing, resulting in degraded apparent performance.

A substantially identical set of three samples was then prepared. The cross-bar member 110 for each of the new samples was then reinforced by ultrasonic welding of a second, identical cross-bar member. Each reinforcing member was identical to the cross-bar member to which it was joined. In each case the reinforcing member was joined to the cross-bar member by an ultrasonic welding process comprising use of two soft copper wire having a diameter of about 1.5 mm as auxiliary energy directors. The wires were placed on the top surface of the cross-bar member along the long dimension. The reinforcing member was then placed atop the wires and cross-bar member. Ultrasonic welding was accomplished using a commercially available Branson Model 920IW unit operated at 20 kHz. Welding time was 800 ms followed by a 1 s hold time. Air pressure of 50 psi was used to hold the two members in compressive contact during the welding and cooling steps. Down speed was selected as the slow setting.

The reinforced samples were then characterized in accordance with the same ISO 527 test method. A comparison of the load at failure of the samples with and without the reinforcing member is shown in Table I below.

TABLE I

| | Stress at Break Without | Stress At Break With |
|---|---|---|
| Sample | Reinforcing Member | Reinforcing Member |
| (Glass Fiber Loading) | (MPa) | (MPa) |
| CAPRON ® 8202 HS | 81 | 37.3 |
| (0) | | |
| CAPRON ® 8231G | 77.2 | 41.6 |
| HS (14%) | | |
| CAPRON ® 8233G | 75.4 | 45.6 |
| HS (33%) | | |

The presence of the reinforcing member is seen in each case to have resulted in a substantial increase in the stress at break (failure), establishing that the reinforcement reduced the effect of flexure in causing failure. In no case was any separation of the reinforcing and cross-bar members seen, indicating the strength of the joint between the members. This testing establishes the utility and efficacy of ultrasonic joining using an auxiliary energy director.

Having thus described the invention in rather full detail, it will be understood that such detail need not be strictly adhered to but that various changes and modifications may suggest themselves to one skilled in the art, all falling within the scope of the present invention as defined by the subjoined claims.

What is claimed is:

1. A method for joining a first workpiece having a first mating surface and a second workpiece having a second mating surface to form an article joined at a joint, at least one of said workpieces being composed of a thermoplastic material, the method comprising the steps of:
a) placing at least one auxiliary energy director in contact with said first mating surface, each of said auxiliary energy directors being substantially continuous and elongated;
b) bringing said second mating surface into close proximity with said first mating surface and into contact with said auxiliary energy director;
c) imposing a compressive force urging said first and second mating surfaces into contact;
d) activating a source that applies ultrasonic vibration to one of said workpieces for a time sufficient to cause melting of at least a portion of at least one of said first and second workpieces;
e) discontinuing said application of ultrasonic vibration; and
f) cooling said workpieces to allow said melted portions to solidify, thereby forming said joined article;
said compressive force being maintained at least through said activating, discontinuing, and cooling steps.

2. The method of claim 1, wherein both of said workpieces are composed of amorphous thermoplastic material.

3. The method of claim 1, wherein both of said workpieces are composed of semicrystalline thermoplastic material.

4. The method of claim 1, wherein one of said workpieces is composed of metallic material.

5. The method of claim 4, wherein the other of said workpieces is composed of an amorphous thermoplastic material.

6. The method of claim 4, wherein the other of said workpieces is composed of a semicrystalline thermoplastic material.

7. The method of claim 1, wherein at least one of said workpieces is composed of a fiber reinforced thermoplastic material.

8. The method of claim 1, wherein at least one of said workpieces is composed of a filled thermoplastic material.

9. The method of claim 1, wherein said auxiliary energy director is composed of a thermoplastic material.

10. The method of claim 9, wherein said auxiliary energy director has a melting point of at most about 60° C. above the melting point of either of said workpieces.

11. The method of claim 1, wherein said auxiliary energy director is composed of a metallic material.

12. The method of claim 11, wherein said auxiliary energy director is composed of a metallic wire.

13. The method of claim 1, wherein said auxiliary energy director has at least one region of transverse concavity.

14. The method of claim 1, wherein said ultrasonic vibration has a frequency ranging from about 15 to 40 kHz.

15. The method of claim 1, wherein said joint is hermetic.

16. The method of claim 1, further comprising the step of supplying additional heat by heating said auxiliary energy director.

17. The method of claim 16, wherein said auxiliary energy director is composed of metal and said auxiliary energy director is heated by passing electrical current therethrough.

18. An article of manufacture comprising a first workpiece having a first mating surface and a second workpiece having a second mating surface, and an auxiliary energy director, said auxiliary energy director being elongated and substantially continuous, at least one of said workpieces being composed of thermoplastic material and said workpieces having been joined by ultrasonic welding of said first mating surface to said second mating surface with said auxiliary energy director interposed therebetween.

19. The article of manufacture of claim 18, wherein both of said workpieces are composed of amorphous thermoplastic material.

20. The article of manufacture of claim 18, wherein both of said workpieces are composed of semicrystalline thermoplastic material.

21. The article of manufacture of claim 18, wherein one of said workpieces is composed of metallic material.

22. The article of manufacture of claim 18, wherein at least one of said workpieces is composed of a fiber reinforced thermoplastic material.

23. The article of manufacture of claim 18, wherein at least one of said workpieces is composed of a filled thermoplastic material.

24. The article of manufacture of claim 18, wherein said auxiliary energy director is composed of a thermoplastic material.

25. The article of manufacture of claim 18, wherein said auxiliary energy director is composed of a metallic material.

26. The article of manufacture of claim 25, wherein said auxiliary energy director is composed of a metallic wire.

27. The article of manufacture of claim 18, wherein said auxiliary energy director has at least one region of transverse concavity.

28. The article of manufacture of claim 18, wherein said ultrasonic vibration has a frequency ranging from about 15 to 40 kHz.

29. The article of manufacture of claim 18, wherein said joint is hermetic.

30. The article of manufacture of claim 18, wherein said auxiliary energy director is composed of metal and said auxiliary energy director is heated by passing electrical current therethrough.

31. An article of manufacture comprising a first workpiece having a first mating surface and a second workpiece having a second mating surface, said article having been produced by a process comprising the steps of:
a) placing at least one auxiliary energy director in contact with said first mating surface, each of said auxiliary energy directors being substantially continuous and elongated;
b) bringing said second mating surface into close proximity with said first mating surface and into contact with said auxiliary energy director;
c) imposing a compressive force urging said first and second mating surfaces into contact;
d) activating a source that applies ultrasonic vibration to one of said workpieces for a time sufficient to cause melting of at least a portion of each of said first and second workpieces;
e) discontinuing said application of ultrasonic vibration; and
f) cooling said workpieces to allow said melted portions to solidify, thereby forming said joined article;
said compressive force being maintained at least through said activating, discontinuing, and cooling steps.
